(19) United States
(12) Patent Application Publication
(10) Pub. No.: US 2026/0055661 A1
(43) Pub. Date: Feb. 26, 2026

(54) PORTABLE AUTOMOBILE STEP ASSEMBLY

(71) Applicant: Amanda Rodela, Fort Worth, TX (US)

(72) Inventor: Amanda Rodela, Fort Worth, TX (US)

(21) Appl. No.: 18/814,540

(22) Filed: Aug. 25, 2024

(51) Int. Cl. E06C 1/38

(52) U.S. Cl. CPC E06C 1/38

(57) ABSTRACT

A portable automobile step assembly includes a base, a plurality of adjustable legs, and a handle assembly. The base is designed to be temporarily stepped on by a person entering an automobile. The plurality of legs is attached to a bottom surface of the base to support the base a distance from a ground or floor surface. The handle assembly is attached to and extends vertically with respect to a top surface of the base and is designed to be gripped for support by a person stepping on the base.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to automobile accessories and devices and more particularly pertains to a new portable automobile step assembly to assist persons who have difficulty entering an automobile, especially automobiles such as trucks and sport utility vehicles with passenger compartments supported higher off of the ground, by providing them with a base to step up on that is adjustable in height.

### (2) Description of Related Art Including Information Disclosed Under 37 CFR 1.97 and 1.98

The prior art relates to automobile accessories and devices. The prior art, as best understood, does not disclose a portable automobile step assembly that has a base, adjustable legs, and a handle assembly to be gripped for support by a person stepping on the base.

### BRIEF SUMMARY OF THE INVENTION

An embodiment of the disclosure meets the needs presented above in a portable automobile step assembly generally comprising a base, a plurality of adjustable legs, and a handle assembly. The base is designed to be temporarily stepped on by a person entering an automobile. The plurality of legs is attached to a bottom surface of the base to support the base a distance from a ground or floor surface. The handle assembly is attached to and extends vertically with respect to a top surface of the base and is designed to be gripped for support by a person stepping on the base.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a portable automobile step assembly according to an embodiment of the disclosure.

FIG. 2 is a bottom perspective view of an embodiment of the disclosure.

FIG. 3 is a side view of an embodiment of the disclosure.

FIG. 4 is a close-up view of a portion of an embodiment of the disclosure.

FIG. 5 is a top perspective view of an embodiment of the disclosure.

FIG. 6 is a close-up view of a portion of an embodiment of the disclosure.

FIG. 7 is a side view of an embodiment of the disclosure.

FIG. 8 is a close-up view of a portion of an embodiment of the disclosure.

FIG. 9 is a side view of an embodiment of the disclosure in use.

### DETAILED DESCRIPTION OF THE INVENTION

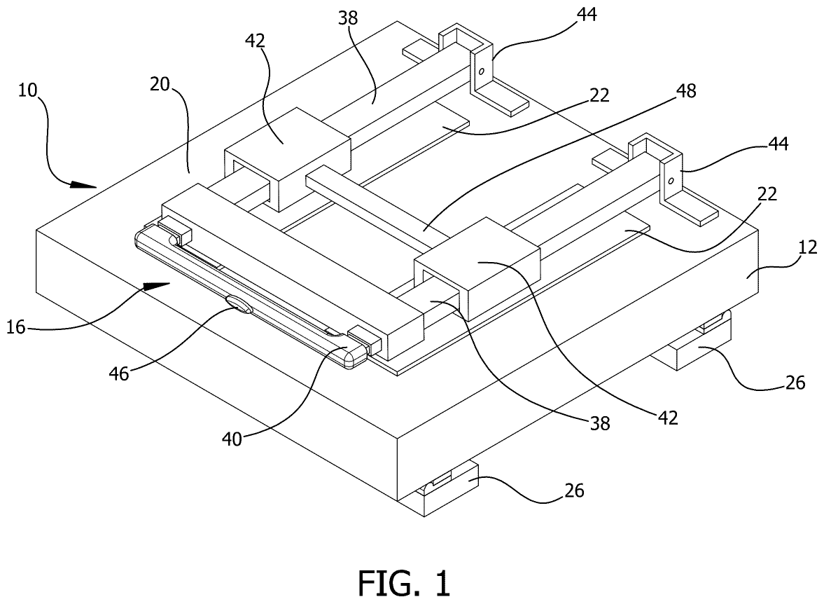

With reference now to the drawings, and in particular to FIGS. 1 through 9 thereof, a new portable automobile step assembly embodying the principles and concepts of an embodiment of the disclosure and generally designated by the reference numeral 10 will be described.

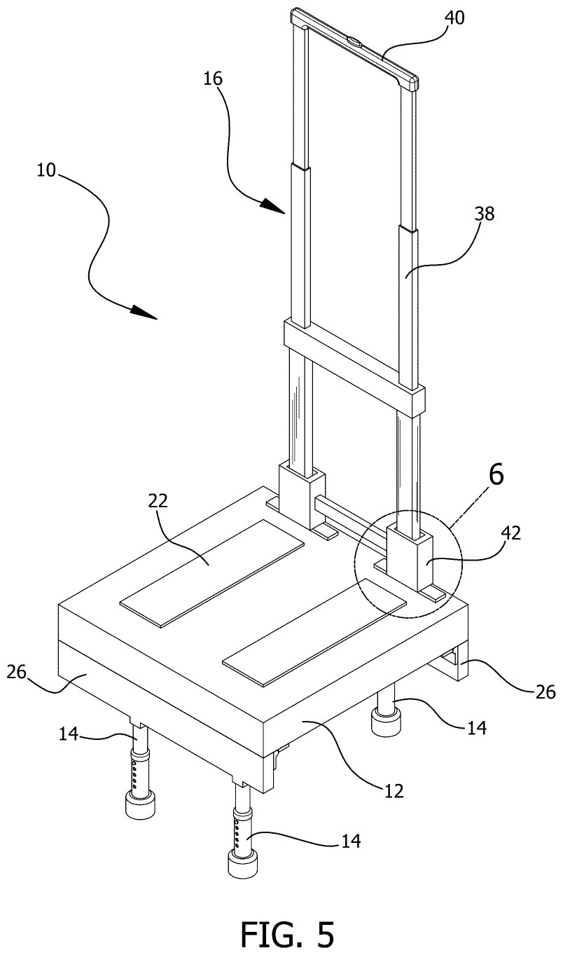

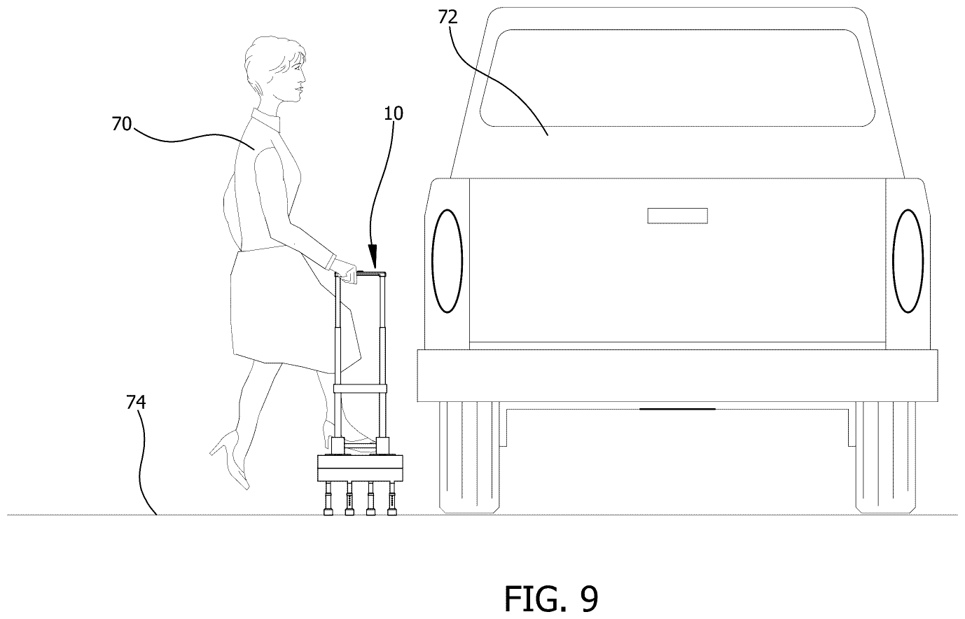

As best illustrated in FIGS. 1 through 9, the portable automobile step assembly 10 generally comprises a base 12, a plurality of adjustable legs 14, and a handle assembly 16. The base 12 is designed to be temporarily stepped on by a person 70 entering an automobile 72, as shown in FIG. 9. The plurality of legs 14 is attached to a bottom surface 18 of the base 12 to support the base 12 a distance from a ground or floor surface 74, as shown in FIGS. 5 and 9. The handle assembly 16 is attached to and extends vertically with respect to a top surface 20 of the base 12 and is designed to be gripped for support by a person 70 stepping on the base 12, as shown in FIG. 9.

The base 12 includes a friction structure 22 positioned on a top surface 20 of the base 12, such as a rubber or elastomer non-slip material, which can be in the form of strips or a single pad.

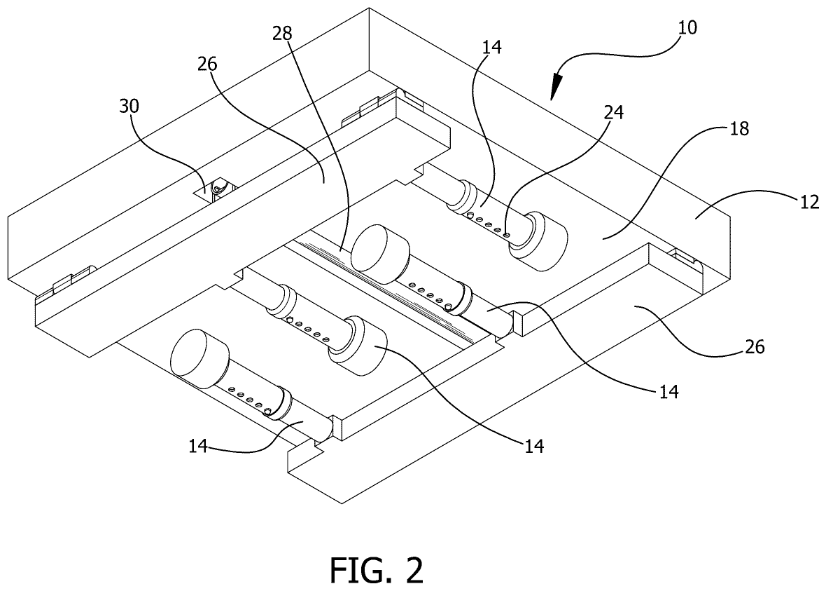

Each of the legs 14 is telescopically adjustable in length. For example, as shown in FIG. 2, the legs 14 can have a push pin 34 locking design with openings 24 for different length adjustments. Each of the legs 14 is pivotably connected to the base 12 to permit the legs 14 to be folded up against the bottom surface 18, as shown in FIG. 2. In the exemplary embodiment shown, the legs 14 include two pairs of legs 14, though more legs 14 could be utilized in other embodiments. Each pair of legs 14 is attached to a corresponding leg mount 26 pivotably connected to the base 12.

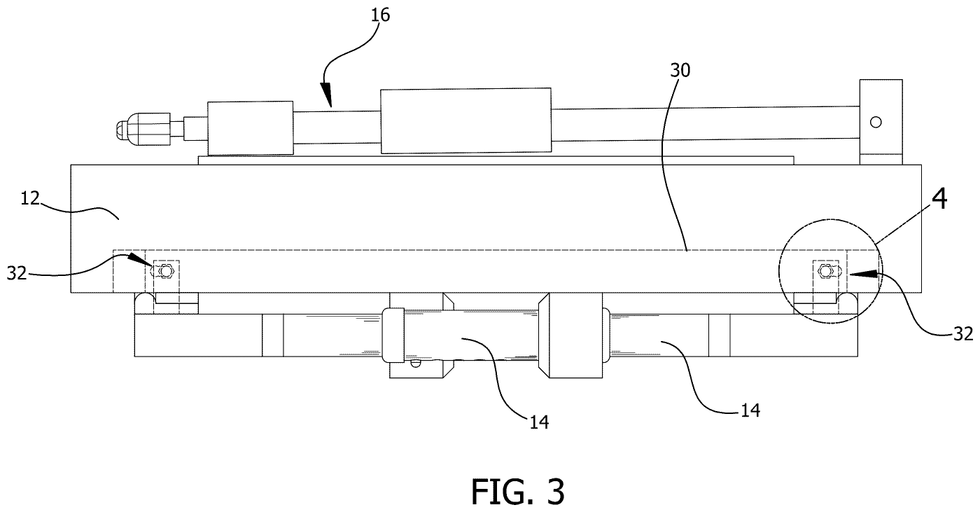

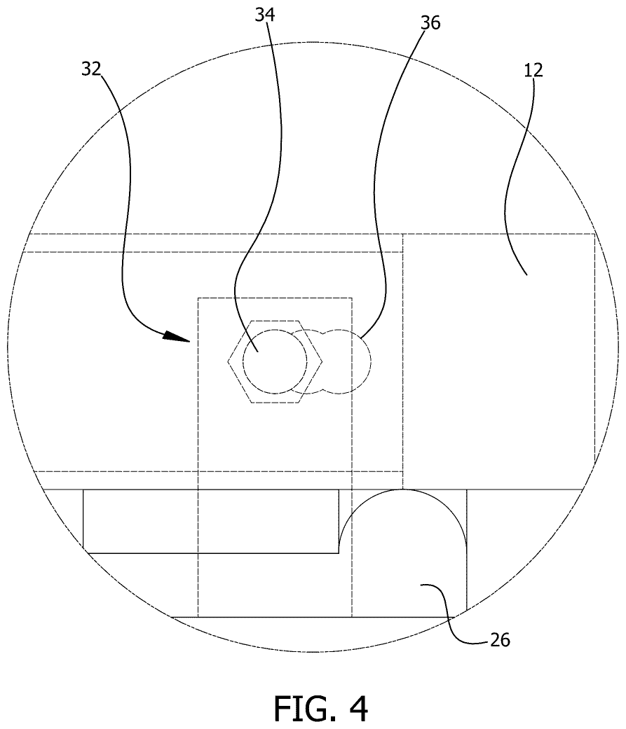

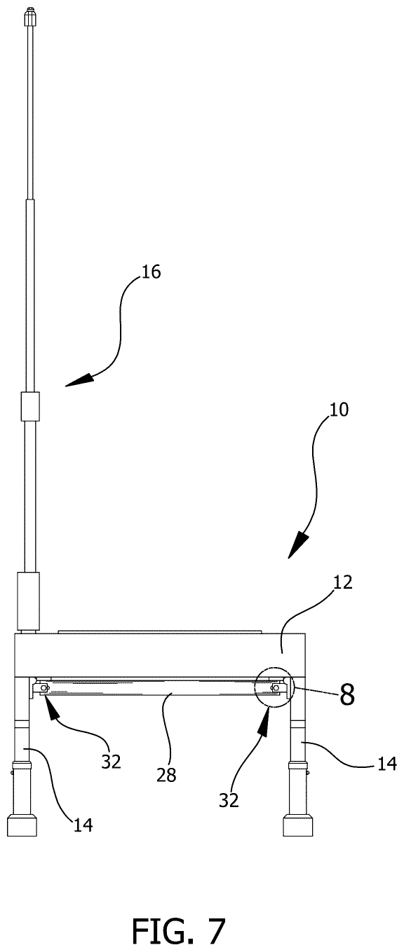

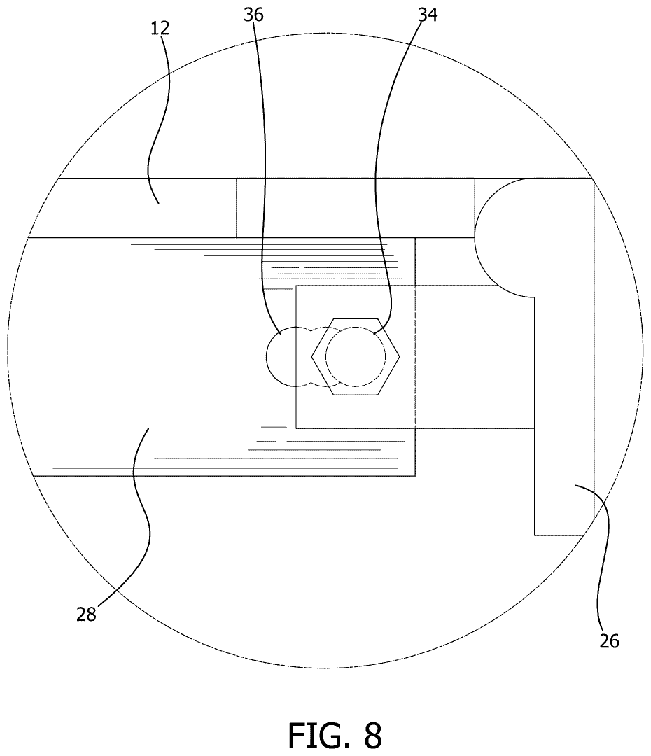

The portable automobile step assembly 10 further includes a brace bar 28 pivotably connected to each of the leg mounts 26 and positioned in a groove 30 in the bottom surface 18 of the base 12. The brace bar 28 is moveable out of the groove 30 when the leg mounts 26 are pivoted away from the bottom surface 18 to lock the leg mounts 26 in place and moveable into the groove 30 when the leg mounts 26 are pivoted toward the bottom surface 18 to store the brace bar 28. FIGS. 4 and 8 show a close-up view of a brace bar bracket assembly 32 that could be used in one possible embodiment for the movement of the brace bar 28. The brace bar bracket assembly 32 includes a pin 34 and a contoured slot 36. When the leg mounts 26 are pivoted toward the bottom surface 18, as shown in FIGS. 3 and 4, the pin 34 is moved along the contoured slot 36 and the brace bar 28 is locked into position inside the groove 30. When the leg mounts 26 are pivoted away from the bottom surface 18, as shown in FIGS. 7 and 8, the pin 34 is moved along the contoured slot 36 to the opposite end and the brace bar 28 is locked into position outside the groove 30 and between the leg mounts 26 to keep the leg mounts 26 from unintentionally collapsing or folding up during use.

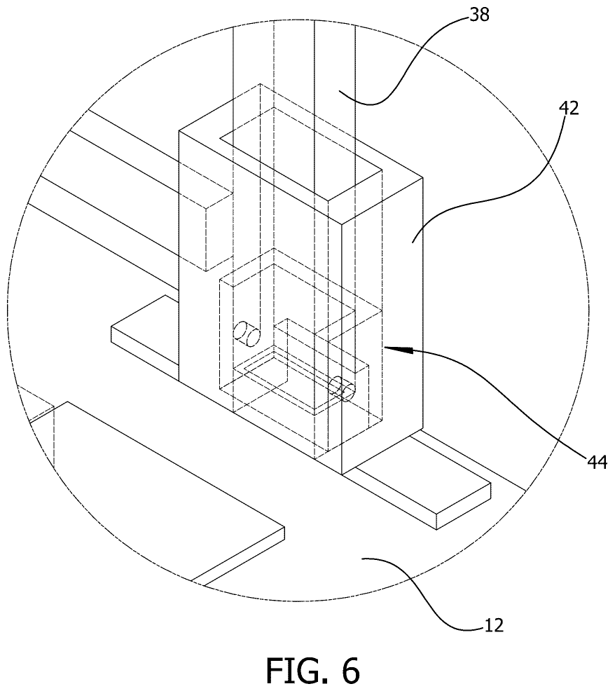

The handle assembly 16 includes a pair of arm portions 38 attached to the base 12 and a handle portion 40 connecting the ends of the pair of arm portions 38. Each of the arm portions 38 is telescopically adjustable in length, much like the handle of a piece of luggage, and can include a release button 46. Each of the arm portions 38 is pivotably connected to the base 12 to permit the handle assembly 16 to be folded up against the top surface 20, as shown in FIG. 1. The handle assembly 16 also includes a pair of retainer blocks 42 connected by a crosspiece 48, wherein each is slidably mounted on a corresponding one of the pair of arm portions 38. As shown in FIGS. 5 and 6, the retainer blocks 42 are slidable over hinge assemblies 44 pivotably connecting the arm portions 38 to the base 12 to prevent unintentional folding of the handle assembly 16 when the arm portions 38 are extended vertically for use by a person 70.

To use the portable automobile step assembly 10, the user unfolds the step assembly 10 from its compact state shown in FIG. 1 to the expanded state shown in FIG. 5, wherein the brace bar 28 automatically locks the leg mounts 26 in place and the retainer blocks 42 can be manually slid or allowed to fall by gravity to lock the handle assembly 16 in place. The user then adjusts the length of the legs 14 to position the base 12 at a desired distance off of the ground 74. The user also extends the handle assembly 16 to a desired height suitable for gripping by the user. The user then places the step assembly 10 next to an open door of an automobile 72 and steps up into the automobile 72. Once in the automobile 72, the user can retrieve the step assembly 10 by lifting it up by the handle assembly 16. The user can then compact the handle assembly 16 back into its compact state for ease of transport, wherein the step assembly 10 could be placed under a seat or in other places in the passenger compartment for easy access. When the user wishes to exit the automobile 72, the user repeats the process to set up the step assembly 10 and then steps down out of the automobile 72.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable automobile step assembly comprising:
a base to be temporarily stepped on by a person entering an automobile;
a plurality of adjustable legs attached to a bottom surface of said base to support said base a distance from a ground or floor surface; and
a handle assembly attached to and extending vertically with respect to a top surface of said base and configured to be gripped for support by a person stepping on said base.

2. The portable automobile step assembly of claim 1, wherein said base comprises a friction structure disposed on a top surface of said base.

3. The portable automobile step assembly of claim 1, wherein each of said legs is telescopically adjustable in length.

4. The portable automobile step assembly of claim 1, wherein each of said legs is pivotably connected to said base to permit said legs to be folded up against the bottom surface.

5. The portable automobile step assembly of claim 4, wherein said legs comprise two pairs of legs, each pair being attached to a corresponding leg mount pivotably connected to said base.

6. The portable automobile step assembly of claim 5, wherein the portable automobile step assembly further comprises a brace bar pivotably connected to each of said leg mounts and disposed in a groove in said bottom surface of said base, wherein said brace bar is moveable out of said groove when said leg mounts are pivoted away from said bottom surface to lock said leg mounts in place and moveable into said groove when said leg mounts are pivoted toward said bottom surface to store said brace bar.

7. The portable automobile step assembly of claim 1, wherein said handle assembly comprises a pair of arm portions attached to said base and a handle portion connecting the ends of said pair of arm portions.

8. The portable automobile step assembly of claim 7, wherein each of said arm portions is telescopically adjustable in length.

9. The portable automobile step assembly of claim 7, wherein each of said arm portions is pivotably connected to said base to permit said handle assembly to be folded up against the top surface.

10. The portable automobile step assembly of claim 9, wherein said handle assembly comprises a pair of retainer blocks connected by a crosspiece and each being slidably mounted on a corresponding one of said pair of arm portions, wherein said retainer blocks are slidable over hinge assemblies pivotably connecting said arm portions to said base to prevent unintentional folding of said handle assembly when said arm portions are extended vertically for use by a person.

11. A portable automobile step assembly comprising:
a base to be temporarily stepped on by a person entering an automobile, wherein said base comprises a friction structure disposed on a top surface of said base;
a plurality of adjustable legs attached to a bottom surface of said base to support said base a distance from a ground or floor surface, wherein:
each of said legs is telescopically adjustable in length,
each of said legs is pivotably connected to said base to permit said legs to be folded up against the bottom surface,
said legs comprise two pairs of legs, each pair being attached to a corresponding leg mount pivotably connected to said base,
the portable automobile step assembly further comprises a brace bar pivotably connected to each of said leg mounts and disposed in a groove in said bottom surface of said base, wherein said brace bar is moveable out of said groove when said leg mounts are pivoted away from said bottom surface to lock said leg mounts in place and moveable into said groove when said leg mounts are pivoted toward said bottom surface to store said brace bar; and
a handle assembly attached to and extending vertically with respect to a top surface of said base and configured to be gripped for support by a person stepping on said base; wherein:
said handle assembly comprises a pair of arm portions attached to said base and a handle portion connecting the ends of said pair of arm portions,
each of said arm portions is telescopically adjustable in length,
each of said arm portions is pivotably connected to said base to permit said handle assembly to be folded up against the top surface,
said handle assembly comprises a pair of retainer blocks connected by a crosspiece and each being slidably mounted on a corresponding one of said pair of arm portions, wherein said retainer blocks are slidable over hinge assemblies pivotably connecting said arm portions to said base to prevent unintentional folding of said handle assembly when said arm portions are extended vertically for use by a person.
